(19) United States
(12) Patent Application Publication
(10) Pub. No.: US 2021/0056440 A1
(43) Pub. Date: Feb. 25, 2021

(54) Synthetic genius machine and knowledge creation system

(71) Applicant: Mark A. Montgomery, Santa Fe, NM (US)

(72) Inventor: Mark A. Montgomery, Santa Fe, NM (US)

(21) Appl. No.: 16/547,271

(22) Filed: Aug. 21, 2019

(51) Int. Cl. G06N 5/02; G06F 16/951; G06N 5/04; G06N 20/00; G06N 10/00

(52) U.S. Cl. CPC G06N 5/022; G06F 16/951; G06N 10/00; G06N 20/00; G06N 5/043

(57) ABSTRACT

A knowledge system of a multi-agent program and computer processors that search the web, databases, knowledge repositories and digital storage to discover thought processes, serendipitous events, and patterns in the recorded work of highly intelligent humans that lead to discoveries, which serve as the basis for synthetic genius simulations. Genius components are converted to proprietary symbolic reasoning. An encrypted process applies machine learning and predictive analytics that match component features for application to a particular query or task. The knowledge creation system synthesizes the data into genius models to create synthetic genius responses including existing discoveries and potential new knowledge. A synthetic genius provides guidance and executes applications according to pre-defined parameters.

### FIELD OF THE INVENTION

The disclosure pertains to the field of artificial intelligence. More specifically, this disclosure relates to the application of knowledge systems consisting of components that include machine learning, natural language processing, pattern recognition, multi-agent systems, predictive analytics, simulations, synthetic computing, virtual reality and quantum computing.

### BACKGROUND

In 1970 Marvin Minsky told Life Magazine, “From three to eight years we will have a machine with the general intelligence of an average human being.” Although much progress has been made in recent years particularly in deep learning (DL), the consensus from leading artificial intelligence (Al) researchers is that artificial general intelligence (AGI), which is also described as super intelligence or strong intelligence, is still decades away as of 2019.

One reason AGI is perceived to be far in the future is that DL may have hit a plateau. Many leading Al scientists including Geoffrey Hinton and Yoshua Bengio have advised researchers to look beyond DL for significant improvements, yet billions of dollars are invested annually in DL and other types of machine learning research, resulting in incremental advances in image processing, natural language processing (NLP), and games.

A second reason that AGI has been unrealized is the power and efficiency of the human brain. The world's largest super computer designed to mimic the human brain is reported to be SpiNNaker, which only approaches one percent of the scale of the human brain, and does so by using massive amounts of human, financial and energy resources.

A third reason that AGI remains elusive is that much of the funding in Al research beyond machine learning is focused on explicit mimicry of the human brain, such as the European Human Brain Project, neuromorphic chips, Microsoft's $1 billion investment in OpenAI, which are thought by many leaders in the field to be decades away from producing AGI.

Various types of efforts have been made to create serendipitous computing, including OTTER (Organized Techniques for Theorem-proving and Effective Research), MACE (Models And Counter-Examples), SerenA by Maxwell et al., and Max, a system designed to provide serendipity as a service (Corneli, et. al). Partially effective efforts in connecting dots of the unknown unknowns have been made in applications benefiting from large amounts of sustained investment, including anti-terrorism, consumer search and e-commerce.

Recent progress has been made in probabilistic modeling, reinforcement learning, generative adversarial networks (GANs) and genetic algorithms. Evolutionary computing is currently being applied to design neural networks (Stanley, et. al., Nature, 2018) that contain similar behavior to human innovation. These and other methods can be applied to human work to accelerate research and discoveries.

Henri Bergson distinguishes between discovery and invention, or new knowledge: “Discovery, or uncovering, has to do with what already exists, actually or virtually; it was therefore certain to happen sooner or later. Invention gives being to what did not exist; it might never have happened” (The Creative Mind. Greenwood Press, 1946).

Unlike other inventions that create cognitive profiles or personas, the invention herein disclosed seeks to reconstruct and accelerate a close approximation of the specific creative thought and discovery processes of each genius for application to specific tasks, such as problem solving and accelerated discovery. Furthermore, the system analyzes the work of experts in each discipline as well as across disciplines to simulate proven methods and to create hypothetical scenarios that may result in new breakthroughs.

Algorithms employed by the system may include reinforcement learning, population algorithms, clustering algorithms and evolutionary algorithms, among others. The numbers and types of potential query matches expand exponentially as the work products are analyzed, which may be processed, analyzed and assimilated with quantum computing, hybrid quantum software, quantum algorithms, and quantum simulations.

### SUMMARY

Although extensive research has been performed on human intelligence in recent decades, and much progress has been made, the mysteries of the brain have not been solved. Christian Jarrett dedicated an entire book to the topic of Great Myths of the Brain (2015, Wiley Blackwell). Among the most studied genius brains was that of Albert Einstein. Despite much conjecture in earlier research on brain size and weight effecting intelligence, Einstein's brain was relatively normal. The compactness of Einstein's supramarginal gyrus within the inferior parietal lobule is thought to represent a highly integrated cortex that may reflect more modules, which could provide more function. It was not the size or weight that mattered in the case of Einstein's brain, but rather efficiency. A mathematician (Gauss) and physicist (Siljestrom) also had similar development of the inferior parietal regions (Witelson, et al., Lancet, 1999).

The world's largest supercomputer attempting to mimic the human brain including cortex functionality is reported to be SpiNNaker at the University of Manchester. Despite the spiking neural network architecture, one million processors and 1,200 interconnected circuit boards, SpiNNaker only approaches one percent of the scale of the human brain. The brain contains approximately 85 billion neurons connected through a quadrillion (10¹⁵) synapses. Moreover, the human brain uses about 20 watts of power versus 10 million watts of power on a supercomputer to complete the same computation. With sufficient investment, time and innovation, the current trajectory of computing innovation and investment is expected to achieve the brute power of the human brain within a few decades. However, the qualitative functions for creativity and imagination are much more complex.

Some species have much simpler brains that achieve higher performance than humans for specific tasks. The same is true in specific functions employing different methods with machine learning. The concept of highly specific targeting to achieve superior results with machine learning is similar to game victories such as IBM in chess and DeepMind playing AlphaGo. As these and other games have demonstrated, the amount of data that may be pre-processed to analyze all finite possibilities to determine optimal path in games is beyond the ability of even world champions. The volume and involved in processing relevant published works of highly intelligent people across disciplines is much greater.

A need therefore exists to apply current state-of-the-art hardware and software to the recorded work of intelligent humans to accelerate the process of achieving genius-like results more broadly beyond the highly controlled environment of gaming. Depending on the query, the quantity and variety of information stored, the system may contain potential matches many times more numerous than the combination of popular games, and is therefore far beyond the ability of any human, hence the need to condense the volume of published works to the most relevant components for repurposing by applying algorithmic techniques to further refine efficiency and continual improvement.

By limiting to proven works and leveraging efficient human brains, data quality and computing efficiency may be improved by over 95%. Simulation fidelity in artificial intelligence may also be improved from current low levels to high levels by employing the system described herein. Once a certain volume and type of data is captured and structured, a system and process is employed to create new knowledge for the specific task required by the individual, group or corporate user. In this manner it may be possible to achieve AGI, or superintelligence.

Serendipitous computing

If Louis Pasteur was correct in 1894 when he said, “In the fields of observation, chance favors only prepared minds”, then we may wish to focus on the most prepared minds that have been proven to achieve breakthroughs across disciplines. It would further be logical to extend the system interactively to those who are also prepared to recognize and apply serendipitous opportunities that are created by the system while assisting in preparation.

The goal of the system is to provide a synthetic genius machine and simulation based on the patterns of those who have proven to demonstrate exceptional levels of brain efficiency and performance for specific tasks, such as problem solving, scientific breakthroughs, advanced engineering designs and creative works of art. The interaction between the genius machine and user or group can occur through voice, text, video, hologram or virtual reality.

Automated agents are deployed to analyze and capture specific thoughts, patterns, and sequences from digitally stored multi-media works of highly creative people, including geniuses with exceptionally high levels of brain efficiency and cognitive function.

It is important to note that the disclosed system is not attempting to build broad cognitive profiles, personas, or other behavioral patterns beyond those relating to specific types of intellectual problem solving. The system attempts to analyze, identify, capture, store, and process specific actions, reactions, decisions, patterns, and serendipitous events for the purpose of simulation and guidance for accelerating discoveries, or in limited cases execution (e.g. low risk, time-dependent scenarios).

### BRIEF DESCRIPTION OF THE DRAWINGS

FIG. 1 is a diagram illustrating the primary components that make up the synthetic genius machine and knowledge system.

FIG. 2 is a diagram providing more detail on the genius components, symbolic reasoning, algorithms and processes.

FIG. 2b a diagram showing the models employed in the disclosure.

FIG. 3 is an illustration of a reactive customer query and response from the knowledge system and genius simulator.

FIG. 3b is a diagram and illustration of a proactive query discovered by the knowledge system, which executes an autonomous pre-structured process.

### DETAILED DESCRIPTION

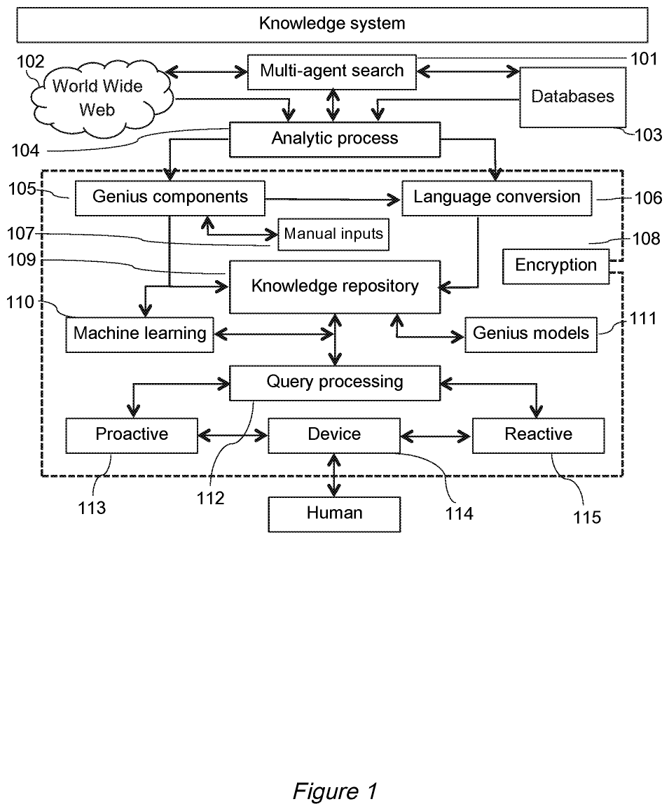

According to various embodiments of the current invention, a multi-agent system searches digitally stored multi-media files of work products developed by highly intelligent and creative people, seeking specific thoughts, patterns, and sequences, which will be described with reference to FIGS. 1-3b. The multi-agent system builds a repository of genius behaviors, patterns and creative processes for the purpose of creating a synthetic genius machine. The preferred manner to communicate query responses is through a genius simulation by employing algorithmic processing to be implemented classically, on quantum hardware or in a hybrid approach.

Exemplary targets of the system include Leonardo da Vinci's notes and inventions, Albert Einstein's published work that led to his theory of special relativity, Charles Darwin's work prior to his theory of evolution, Johannes Kepler's laws of planetary motion, Galileo Galilei's laws of falling body, Thomas Edison's invention of “Improvement In Electric Lights” and large numbers of others throughout recorded history. Additional exemplary targets may include the works of leading scientists, engineers, inventors, professionals and artists in each discipline and field of study or across disciplines. The disclosed system also builds serendipity and synthetic models. The genius models can be queried individually or any combination thereof depending on specific needs.

FIG. 1 shows a high level architecture of the knowledge system. The multi-agent search 101 crawls the World Wide Web 102 and various databases 103 seeking specific characteristics. A software program then performs an analytical process 104 to capture genius components. Language conversion 106 and encryption 108 is performed prior to storing in the knowledge repository 109. Human workers may augment the knowledge system with manual inputs 107 of observations and insights in cases where documented works are unavailable or lacking sufficient information to build rigorous models.

A plurality of machine learning 110 algorithms are applied to the genius components to build genius models 111, which prepares the system for query processing 112 to respond with a synthetic genius simulation. Algorithms employed by the system include reinforcement learning, long short-term memory, recurrent neural networks, population algorithms, clustering algorithms and evolutionary algorithms.

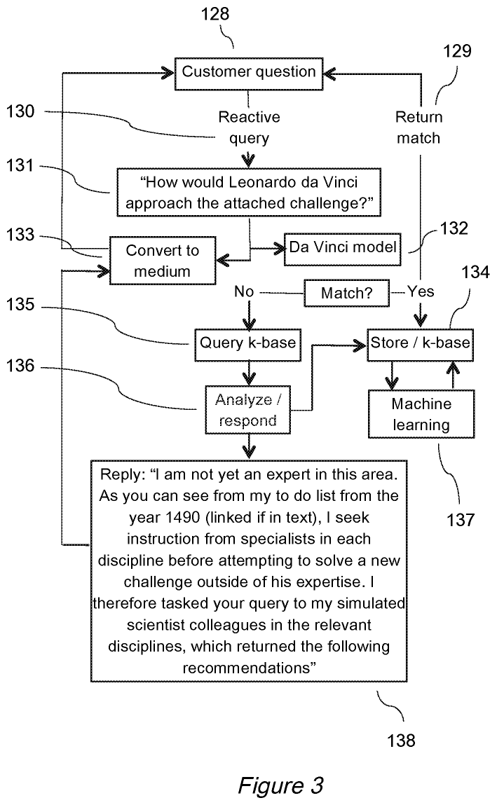

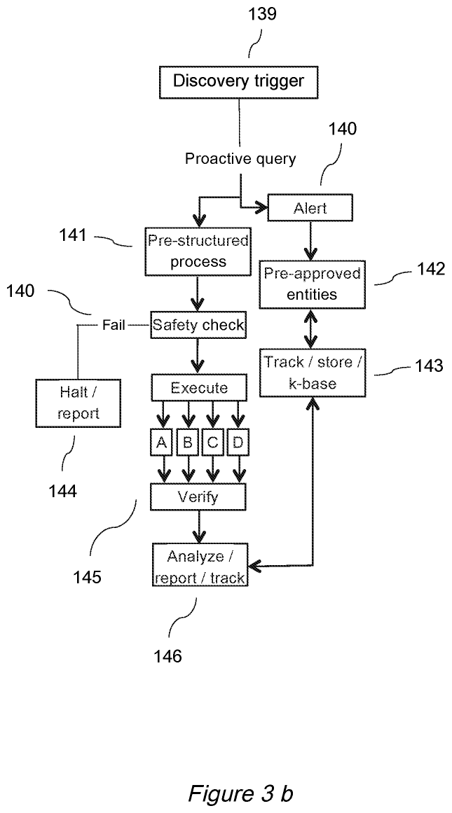

The multi-agent knowledge system architecture provides for two types of query processing 112 through a computer device 114 interface, including a reactive query 115 from customer users and a proactive query 113 triggered by an ongoing system process, which is pre-programed to execute an alert 140 (FIG. 3b) or function upon discovering information that matches specific characteristics.

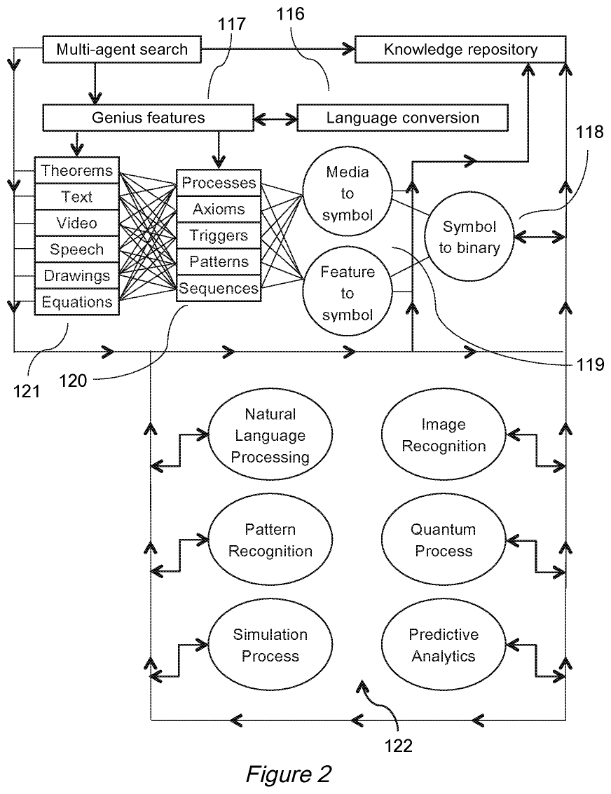

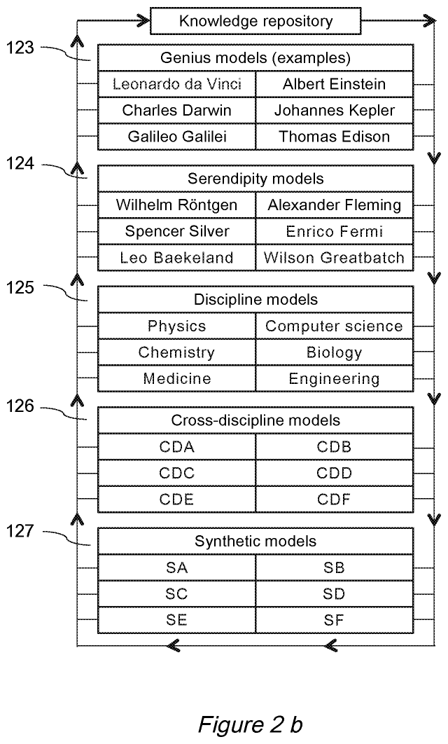

FIG. 2 illustrates the multi-agent search engine collecting individual genius features 117, which consist of text, video, speech, drawings and equations 121 that may include theorems, articles, notes, sketches, books, correspondence with peers, lectures, interviews and other recorded multi-media works. A software program analyzes the subject's works and captures unique characteristics or commonalities found that qualify for inclusion in the genius features 117.

Another software program analyzes the genius components for processes, axioms, triggers, patterns and sequences 120 with a focus on new discoveries. The captured data is converted to a proprietary language 116 to improve security and efficiency throughout the process.

In implementations described herein, symbolic representation of genius features 117 are achieved by converting from natural language and multimedia binary format to symbols 118. The proprietary language may contain graphical, textual and tabular components with a corresponding configurable syntax (not shown). A conversion process 133 (FIG. 3) in reverse order is employed from the proprietary language to natural language to communicate with the user. Individual features are also converted to symbols 119 that represent specific methods of discovery. The use of symbols to represent specific genius features achieves a dual purpose by providing a proprietary encryption and a significant compression of data volume required to send over networks. An individual symbol may represent many megabytes of data or potentially more.

The various computing methods for the system include natural language processing, image recognition, pattern recognition, quantum processes, simulation processes and predictive analytics 122.

FIG. 2b illustrates the disclosed models including genius models 123. The components features are converted from natural language and multi-media into a proprietary language of symbols, which is stored for analytical processing. The disclosed knowledge system searches, collects, analyzes and synthesizes a plurality of component features that contain both intentional and serendipitous discoveries 124. Models are constructed for each type of identified serendipitous event, process or sequence, which are called upon based on probabilistic matches with reactive and proactive queries. Serendipitous features and models can be combined with other component features and models to create new synthetic models 127.

One embodiment of the system analyzes the work products and patterns of geniuses for modeling within each discipline 125 during the creative process of research and discovery.

In another embodiment the system builds genius components and models by analyzing and comparing work products across disciplines 126 for accelerating discovery of what has proven to work in other disciplines.

An implementation of the system is to create synthetic models 127 and genius simulations in multi-media based on a plurality of data run on the work products stored in the knowledge repository, which can be communicated interactively with the user by text, voice, virtual reality or hologram (FIG. 3). The synthetic models are initially based on genius features, models and patterns. Predictive algorithms and machine learning algorithms are then applied to build hypothetical scenarios. As the data quality and quantity improve, synthetic models can be built and matured, with the expectation that synthetic models will surpass the scale and accuracy of other machines and methods.

(0039) According to various embodiments of the system, a multi-agent system is tasked to analyze, detect, and capture patterns that led to serendipitous discoveries 124, such as the x-ray discovery by Wilhelm Conrad Röntgen, Alexander Fleming's discovery of penicillin, and many others. Jonathan Zilberg differentiates chance and serendipity as follows: “Chance is an event while serendipity is a capability dependent on bringing separate events, causal and non-causal together through an interpretive experience put to strategic use,” (Applied Anthropology: Unexpected Spaces, Topics and Methods, pages 79-92. Routledge, 2015). Whereas intentional discoveries are usually based on hypotheses, serendipity is typically due to a dynamic environment with a sufficient volume and type of interactions to improve upon the probabilities of beneficial accidents.

Representative synthetic genius

FIG. 3 discloses an example that provides a user with a detailed description of how a particular genius might approach a set of problems. For example, a human user may query the system as follows: “how would Leonardo da Vinci approach the attached challenge?” 131. Once the multi-agent system analyzes the attached document, it will then attempt to match with the Da Vinci model 132 stored in the knowledge repository. If a match exists, the Da Vinci simulation will return the user query with the match 129. If the knowledge base does not contain a match 135, the knowledge base will search the Da Vinci features for an alternative response 136.

In the current example query an alternative was found and returned to the user by the Da Vinci simulation as follows: “I am not yet an expert in this area. As you can see from my to do list from the year 1490 (linked to location if in text), I seek instruction from specialists in each discipline before attempting to solve a new challenge outside of his expertise. I therefore tasked your query to my simulated scientist colleagues in the relevant disciplines, which returned the following recommendations” 138. The response is stored 134 for continuous improvement with a plurality of machine learning algorithms. The mix of algorithms selected depends on the nature of the query and type of genius features involved, such as images, text or recordings.

In some cases, depending on a large number of variables in the specific query, the genius model and simulation may request additional time before answering the query so the multi-agent search engine and knowledge system can seek additional information to analyze and refine the problem set to prepare a more informed response, for example either through new data on Da Vinci for the current query, or by building a synthetic model that responds to the query with new knowledge or a new hypothesis.

FIG. 3b illustrates a proactive query whereby new information analyzed in the knowledge repository discovers a trigger 139, which executes a pre-programmed course of action. One example may be a robotic manufacturing process 141 in a laboratory to test existing chemicals, materials or processes for a new application. Prior to executing a test the system runs the process through a safety check 140. If the compound contains a mix of chemicals with known risk, the test is halted and reported to the appropriate human lab technicians. If the safety check is approved, the process is executed, verified 145, analyzed 146, tracked and stored 143, reporting back to pre-approved entities 142.

Implementing system with quantum computing

A quantum computer is a device for performing calculations using quantum mechanics to represent information. Data is stored using quantum bits, or qubits. The numbers and types of potential query matches expand exponentially as the work products are analyzed, which may be applied with quantum computing, hybrid quantum systems, quantum algorithms, and quantum simulations.

In one embodiment of the system, a quantum computer is tasked to process bits, strings, and components of encrypted knowledge called from the genius repository for analysis and compiling (not shown).

In another embodiment of the system, the knowledge creation system runs automated algorithms on the genius components to produce a repository of fitted binaries. If an appropriate genius component does not exist in the knowledgebase for a particular query or task, the system can provide the option to the user or group to run pre-loaded hypothetical scenarios.

Knowledge currency

An implementation of the system is to perform analytics on the genius components collected from each entity and track throughout the process to assign values and weights for establishing a knowledge currency, which can be applied and exchanged for current knowledge work or works protected by contract or copyright.

Distributed artificial intelligence operating system

The disclosed system can be combined with U.S. Pat. No. 8,005,778, which is incorporated herein by reference in its entirety, as components of a distributed artificial intelligence operating system.

One skilled in the art will recognize that the above methods and components are merely exemplary, and that the system of the present invention can be implemented in any combination of domains.

What is claimed is:

1. A knowledge system comprising: a multi-agent search engine that crawls databases and knowledge base seeking the works of highly intelligent and creative people; a computer program to analyze text, drawings, equations, voice, video, and other recordings to discover and capture specific characteristics, sequences of events, behaviors, reactions, processes and patterns related to solving problems and that lead to breakthrough innovations and inventions; a computer program that provides guidance for accelerating discoveries, or in limited cases execution (e.g. low risk and time dependent scenarios).

2. A method of claim 1, further comprising of a computer program that analyzes multimedia files of highly intelligent and creative people to produce one or more simulation models.

3. A computer device of claim 1, further comprising of a computer program that generates a repository of breakthrough patterns, creative processes and genius features.

4. A computer device of claim 1, further comprising a computer program that analyzes and processes specific actions, reactions, decisions and patterns that led to serendipitous events for the purpose of simulating hypothetical breakthroughs.

5. A computer device of claim 1, further comprising of a computer program executes a query engine and user interface that compiles, converts and translates from voice, text, virtual reality, mixed reality or holography to and from a proprietary encrypted language for efficient processing by machine learning and quantum computing.

6. A computer device of claim 1, further comprising of a computer program that stores data in one or more knowledge repositories, which may include relational databases, knowledge graphs and other forms of data stores.

7. A symbolic representation of individual genius components and features, comprising: a computer program that synthesizes bits, strings, sequences and patterns of multi-media work products into an executable formulaic application;
and a computer program that creates a key for decoding the executable formulaic symbolic representations.

8. A computer device of claim 7, further comprising of a computer program that matches the stored executable symbolic applications into a series or parallel computer programs and combined into larger and more complex applications.

9. A genius simulator, comprising: one or more processors for computational elements to be implemented classically, on quantum hardware, quantum-like software, or in a hybrid form; and a computer program that executes a translation and conversion process from a proprietary encrypted language to multimedia query responses and/or upon discovery of information that triggers proactive communications.

10. A computer device of claim 9, further comprising of a computer program provides an interactive interface through computer devices that communicate by voice, text, video, holograms or virtual reality.
